(19) United States
(12) Patent Application Publication
(10) Pub. No.: US 2026/0024024 A1
(43) Pub. Date: Jan. 22, 2026

(54) MACHINE VISION SYSTEM, MACHINE VISION METHOD AND MACHINE VISION APPARATUS

(71) Applicant: DeCloak Intelligences Co., Taipei City (TW)

(72) Inventor: Yao-Tung Tsou, Taipei City (TW)

(73) Assignee: DeCloak Intelligences Co., Taipei City (TW)

(21) Appl. No.: 19/266,196

(22) Filed: Jul. 11, 2025

Related U.S. Application Data
(60) Provisional application No. 63/672,210, filed on Jul. 16, 2024.

(51) Int. Cl. G06N 20/20; G06F 21/62; G06V 40/16; G06V 40/20

(52) U.S. Cl. CPC G06N 20/20; G06F 21/6254; G06V 40/172; G06V 40/20; G06V 2201/07

(57) ABSTRACT

Provided is a machine vision system including multiple machine vision apparatuses and a server apparatus. The machine vision apparatuses are respectively disposed to acquire an image of a regional space where each machine vision apparatus is located, and analyze objects in the images and a correlation thereof with the regional spaces by using a first machine learning model. The server apparatus provides analysis results and model parameters of the first machine learning model uploaded by the machine vision apparatuses to a second machine learning model to construct vision information of an overall space. Each machine vision apparatus downloads the vision information of the overall space and model parameters of the second machine learning model from the server apparatus and uses the same to update the first machine learning model, and, in response to receiving a task, generates instructions to execute the task by using the updated first machine learning model.

### CROSS-REFERENCE TO RELATED APPLICATION

This application claims the priority benefits of U.S. provisional application Ser. No. 63/672,210, filed on Jul. 16, 2024. The entirety of the above-mentioned patent application is hereby incorporated by reference herein and made a part of this specification.

### BACKGROUND

### Technical Field

The disclosure relates to a machine vision system, method, and apparatus.

### Related Art

Machine Vision (MV) is a technology based on image processing, widely applied in industrial automated inspection, program control, and robot guidance. After obtaining monitoring images, the machine vision system may extract information from the images as needed. The information may be simple pass/fail messages or complex data sets, such as the identity, position, and orientation of each object appearing in the image. In robot guidance applications, machine vision can integrate images from multiple cameras, automatically generate spatial information, enabling robots to identify the position and orientation of objects in space, thereby executing tasks.

After obtaining monitoring images, existing machine vision systems identify the identity of objects in the images through database matching. However, this method requires pre-storing face images and identity data for query or verification, seriously infringing on personal privacy, and if the stored data is leaked, the identity information of personnel may be exposed, thereby affecting the personal safety of personnel. In addition, existing machine vision systems can only construct vision information of the space around themselves, with limited visual range. Therefore, how to expand the visual range and improve image recognition accuracy while protecting personnel privacy is one of the important issues in this field.

### SUMMARY

The disclosure provides a machine vision system, method, and apparatus that may enhance visual recognition and task execution.

A machine vision system of the disclosure includes multiple machine vision apparatuses and a server apparatus. The machine vision apparatuses are respectively disposed to acquire an image of a regional space where each machine vision apparatus is located, and analyze at least one object in the image and a correlation between each object and the regional space by using a first machine learning model. The server apparatus receives analysis results and multiple first model parameters of the first machine learning model uploaded by each machine vision apparatus, and provides to a second machine learning model to construct vision information of an overall space including all regional spaces. Each machine vision apparatus downloads the vision information of the overall space and a set of second model parameters of the second machine learning model from the server apparatus to update the first model parameters of the first machine learning model, and, in response to receiving a task, generates instructions to execute the task by using the updated first machine learning model.

In an embodiment of the disclosure, the machine vision apparatus includes using a first privacy visual language model (PVLM) to identify the objects in the images, and analyzing the correlation between each object and the regional spaces to generate regional contextualized embeddings of each object in the regional space. The machine vision apparatus further performs de-identification processing on a face image of each object to generate de-identified features, and compares the de-identified features with pre-stored features in a feature database to identify identities of the objects.

In an embodiment of the disclosure, the machine vision apparatus further analyzes a human figure and an action of each object by using the first privacy visual language model, and covers a human figure mask on the human figure to generate a de-identified image.

In an embodiment of the disclosure, the machine vision apparatus further inputs the regional contextualized embeddings, the actions and identities of each object into a regional AI model, and trains the regional AI model using multiple tasks to generate a set of model parameters of instructions adapted for the regional AI model to execute the task.

In an embodiment of the disclosure, the regional contextualized embeddings include image tokens and text tokens of the objects, and image caption, image question answering, and space navigation between the object and the tokens are generated.

In an embodiment of the disclosure, the server apparatus includes fusing the analysis results uploaded by each machine vision apparatus by using a second privacy visual language model to generate multiple global contextualized embeddings of each object in the overall space.

In an embodiment of the disclosure, the server apparatus further trains a global AI model by using the first model parameters of the first machine learning model uploaded by each machine vision apparatus to generate the set of second model parameters adapted for identifying all objects in the overall space.

In an embodiment of the disclosure, the global AI model includes performing federated learning by using the first model parameters of the first machine learning model uploaded by each machine vision apparatus to generate the set of second model parameters.

In an embodiment of the disclosure, the machine vision apparatuses are respectively disposed in corresponding ones of multiple user devices, each machine vision apparatus, in response to the user device receiving a task, acquires a current image of the regional space where the user device is located, analyzes the objects in the current image of the regional space and the correlation between each object and the regional space by using the updated first machine learning model, obtains the instructions to execute the task, and sends the instructions to the user device.

In an embodiment of the disclosure, each machine vision apparatus is integrated with at least one of the corresponding user device and the server apparatus into a single device.

A machine vision method of the disclosure, adapted for a machine vision system including multiple machine vision apparatuses and a server apparatus connected to each machine vision apparatus, the method includes acquiring an image of a regional space where each machine vision apparatus is located by each machine vision apparatus, and analyzing at least one object in the image and a correlation between each object and the regional space by using a first machine learning model; receiving the analysis results and multiple first model parameters of the first machine learning model uploaded by each machine vision apparatus by the server apparatus, and providing to a second machine learning model to construct vision information of an overall space including all regional spaces; and downloading the vision information of the overall space and a set of second model parameters of the second machine learning model from the server apparatus by each machine vision apparatus, to update the first model parameters of the first machine learning model, and, in response to receiving a task, generating instructions to execute the task by using the updated first machine learning model.

In an embodiment of the disclosure, the step of analyzing, by each machine vision apparatus, the at least one object in the image and the correlation between each object and the regional space by using the first machine learning model includes using a first privacy visual language model to identify the objects in the images, and analyzing the correlation between each object and the regional space to generate regional context embeddings of each object in the regional space, and the step of analyzing, by each machine vision apparatus, the at least one object in the image and the correlation between each object and the regional space by using the first machine learning model further includes performing de-identification processing on a face image of each object to generate de-identified features, and comparing the de-identified features with pre-stored features in a feature database to identify an identity of the object.

In an embodiment of the disclosure, the step of analyzing, by each machine vision apparatus, the at least one object in the image and the correlation between each object and the regional space by using the first machine learning model further includes analyzing a human figure and an action of each object by using the first privacy visual language model, and covering a human figure mask on the human figure to generate a de-identified image.

In an embodiment of the disclosure, the step of analyzing, by each machine vision apparatus, the at least one object in the image and the correlation between each object and the regional space by using the first machine learning model further includes inputting the regional context embeddings, the action and identity of each object into a regional AI model, and training the regional AI model using multiple tasks to generate a set of model parameters of the instructions adapted for the regional AI model to execute the task, in which the regional context embeddings include image tokens and text tokens of the objects, and may execute visual language model applications such as image description, image question answering, and space navigation between the objects and the tokens.

In an embodiment of the disclosure, the step of constructing, by the server apparatus, the vision information of the overall space including all regional spaces by using the second machine learning model includes fusing the analysis results uploaded by each machine vision apparatus by using a second privacy visual language model to generate multiple global context embeddings of each object in the overall space.

In an embodiment of the disclosure, the step of constructing, by the server apparatus, the vision information of the overall space including all regional spaces by using the second machine learning model further includes training a global AI model by using the first model parameters of the first machine learning model uploaded by each machine vision apparatus to generate the set of second model parameters adapted for identifying all objects in the overall space.

In an embodiment of the disclosure, the global AI model includes performing federated learning by using the first model parameters of the first machine learning model uploaded by each machine vision apparatus to generate the set of second model parameters.

In an embodiment of the disclosure, the machine vision apparatuses are respectively disposed in corresponding multiple user devices, and the step of generating, by each machine vision apparatus, the instructions to execute the task by using the updated first machine learning model in response to receiving the task includes acquiring a current image of the regional space where the user device is located, analyzing the objects in the image of the regional space and the correlation between each object and the regional space by using the updated first machine learning model, obtaining the instructions to execute the task, and sending the instructions to the user device.

A machine vision apparatus of the disclosure disposed in a user device, includes a communication device, a storage device, and a processor. The communication device is configured to be communicatively connected with a server apparatus. The storage device is configured to store multiple first model parameters of a first machine learning model. The processor is coupled to the communication device and the storage device, and configured to acquire an image of a regional space where the user device is located, analyze at least one object in the image and a correlation between each object and the regional space by using a first machine learning model, and upload analysis results to a server apparatus, download vision information of an overall space including all regional spaces and a set of second model parameters of a second machine learning model from the server apparatus to update the multiple first model parameters of the first machine learning model, in which the server apparatus collects the analysis results and the first model parameters of the first machine learning model uploaded by multiple machine vision apparatuses, and provides to the second machine learning model to construct the vision information of the overall space including all regional spaces, and, in response to the user device receiving a task, generates instructions to execute the task by using the updated first machine learning model, and sends the instructions to the user device.

In an embodiment of the disclosure, the machine vision apparatus is integrated with at least one of the user device and the server apparatus into a single device.

Based on the above, the machine vision system, method, and apparatus of the disclosure, through disposing machine vision apparatuses on edge user devices, acquire and analyze the image of the regional space where the user device is located, and the server apparatus collects and integrates analysis results from multiple machine vision apparatuses to construct vision information of overall space. Thereby, the machine vision apparatus, through obtaining the vision information of the overall space from the server apparatus, may enhance its own visual recognition and task execution capabilities.

### BRIEF DESCRIPTION OF THE DRAWINGS

FIG. 1A is an architecture diagram of a machine vision system according to an embodiment of the disclosure.

FIG. 1B is a schematic diagram of multi-view fusion according to an embodiment of the disclosure.

FIG. 2 is a schematic diagram of the machine vision system according to an embodiment of the disclosure.

FIG. 3 is a block diagram of a machine vision apparatus according to an embodiment of the disclosure.

FIG. 4 is a flowchart of a machine vision method according to an embodiment of the disclosure.

FIG. 5 is a schematic diagram of task execution and AI model training according to an embodiment of the disclosure.

FIG. 6 is a schematic diagram of vision fusion and a global AI model training according to an embodiment of the disclosure.

FIG. 7 is a schematic diagram of executing a task according to an embodiment of the disclosure.

### DESCRIPTION OF THE EMBODIMENTS

A machine vision system provided by an embodiment of the disclosure is an innovative, privacy-aware, multi-modal plug-and-play intelligent robot system, which integrates privacy-secure perception, multi-view fusion, cognitive inspiration, spatial intelligence, and robot learning technologies, and adopts federated learning, differential privacy, homomorphic encryption technology combined with AI model to execute tasks, thereby simultaneously protecting personal privacy and sensitive data security.

A machine vision apparatus provided by an embodiment of the disclosure may be integrated with existing user devices equipped with cameras or video cameras or robots through hardware interfaces such as universal serial bus (USB) or peripheral component interconnect express (PCIe), and may provide comprehensive visual fusion and perspective coverage for user devices located at edges. In the embodiment, the multi-modal privacy visual language model (PVLM) adopted by the machine vision apparatus can ensure efficient machine vision processing and secure face and human figure de-identification, and protect the confidentiality of sensitive data and human privacy.

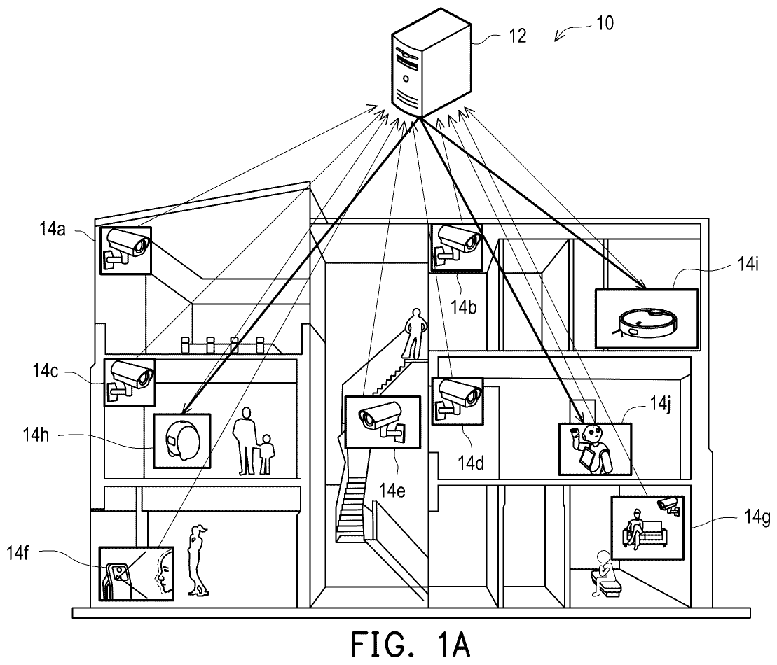

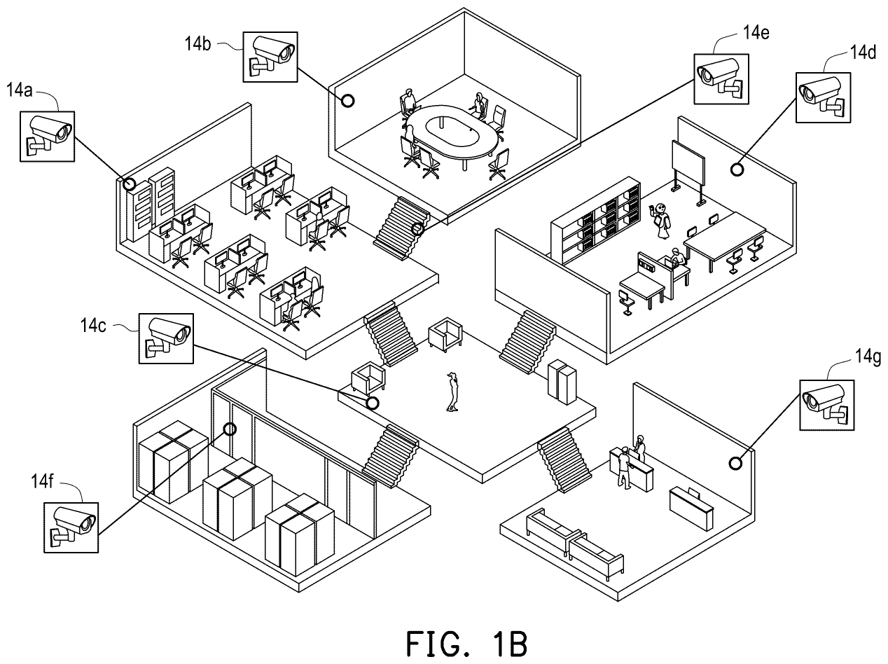

FIG. 1A is an architecture diagram of a machine vision system according to an embodiment of the disclosure, and FIG. 1B is a schematic diagram of multi-view fusion according to an embodiment of the disclosure. Referring to FIG. 1A, a machine vision system 10 of the embodiment of the disclosure collects views from various edge devices 14a to 14j equipped with cameras or video cameras (including, for example, surveillance cameras, access control systems, robots) by a server apparatus 12, through online artificial intelligence (AI) learning, so that the edge devices 14a to 14j may obtain more vision information, thereby effectively and accurately executing tasks. The edge devices 14a to 14j, for example, are disposed at different locations on multiple floors of a building, may acquire views of different regions, and the views acquired by each edge device 14a to 14j may be converted into contextualized embeddings through the privacy visual language model and shared with the server apparatus 12.

Referring to FIG. 1B, the server apparatus 12, for example, adopts multi-view fusion technology, uses contextualized embeddings from multiple views from the edge devices 14a to 14g, reconstructs synthetic spatial vision through a visual foundation model, and generates vision information of an overall space, thereby expanding the visual range. For example, by redrawing multiple views provided by the edge devices 14a to 14g, scenes of each floor inside the building can be reconstructed. The vision information may be synchronously transmitted back to the edge devices 14h to 14j, enabling each edge device 14h to 14j to accurately complete assigned tasks by utilizing vision information with expanded range.

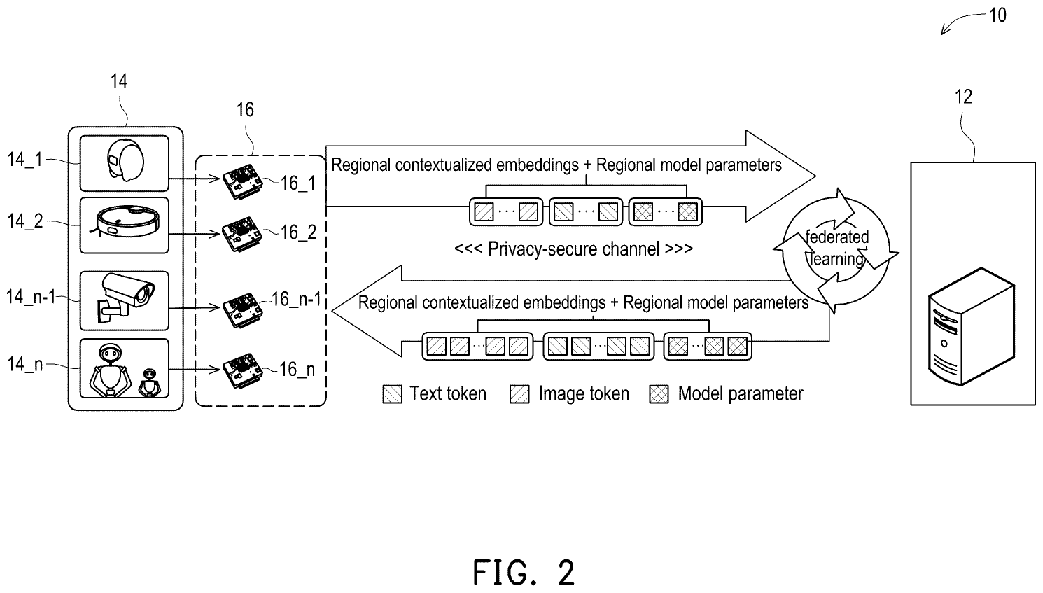

FIG. 2 is a schematic diagram of the machine vision system according to an embodiment of the disclosure. Referring to FIG. 2, the machine vision system 10 of the embodiment of the disclosure includes the server apparatus 12 and multiple machine vision apparatuses 16.

Machine vision apparatuses 16_1 to 16_n, for example, are connected to existing user devices 14_1 to 14_n equipped with cameras or video cameras through hardware interfaces such as universal serial bus (USB) or peripheral component interconnect express (PCIe), or integrated with user the devices 14_1 to 14_n as the same device. The user devices 14_1 to 14_n, for example, are edge devices such as IP cam, access control systems, cleaning robots, service robots, pet robots, smart home appliances, or personal devices such as mobile phones, tablets, laptops, desktop computers. This embodiment does not limit the types and quantities thereof.

The server apparatus 12, for example, is a private server located in the cloud, which may collect vision information (including, for example, regional context embeddings, regional model parameters) of regional space uploaded by the machine vision apparatuses 16_1 to 16_n and perform fusion calculations to construct vision information of the overall space and global model parameters. In other embodiments, the server apparatus 12 may be disposed or installed anywhere on the Internet, Intranet, or other network environment, which is not limited in the embodiments.

The machine vision apparatuses 16_1 to 16_n may provide comprehensive visual fusion and perspective coverage for the user devices 14_1 to 14_n by downloading vision information (including global context embeddings, global model parameters) of the overall space from the server apparatus 12, and accurately complete assigned tasks accordingly. In some embodiments, each machine vision apparatus 16_1 to 16_n may be integrated with the server apparatus 12 as the same device to have the function of collecting and fusing vision information provided by the server apparatus 12. That is, each machine vision apparatus 16_1 to 16_n can operate independently without the server apparatus 12, and may be connected with other machine vision apparatuses 16_1 to 16_n in series to obtain vision information of the overall space.

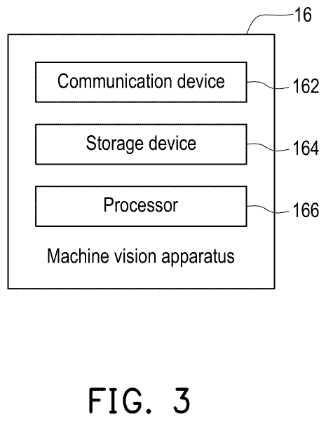

In detail, FIG. 3 is a block diagram of the machine vision apparatus according to an embodiment of the disclosure. Referring to FIG. 3, the machine vision apparatus 16 includes a communication device 162, a storage device 164, and a processor 166.

The communication device 162, for example, includes devices supporting communication protocols such as wireless fidelity (Wi-Fi), radio frequency identification (RFID), Bluetooth, infrared, near-field communication (NFC), or device-to-device (D2D), or devices supporting Internet connection, so as to establish communication links with the server apparatus 12. In some embodiments, the communication device 162 further includes hardware interfaces such as universal serial bus (USB) or peripheral component interconnect express (PCIe) for connecting or communicating with the user device 14, so as to obtain images acquired by the user device 14.

The storage device 164, for example, is any type of fixed or removable random access memory (RAM), read-only memory (ROM), flash memory, hard disk or similar components or a combination of the above components, so as to store computer programs that may be executed by the processor 166. In some embodiments, the storage device 164 may further be used to store model parameters of machine learning models and a feature database recording pre-stored de-identified/encrypted features (such as differential privacy, homomorphic encryption) of objects to be identified.

The processor 166, for example, is a central processing unit (CPU), or other programmable general-purpose or special-purpose microprocessor, microcontroller, digital signal processor (DSP), programmable controller, application specific integrated circuits (ASIC), programmable logic device (PLD) or other similar devices or a combination of these devices. In some embodiments, the processor 166 may load computer programs from the storage device 164 to execute a machine vision method of embodiments of the disclosure.

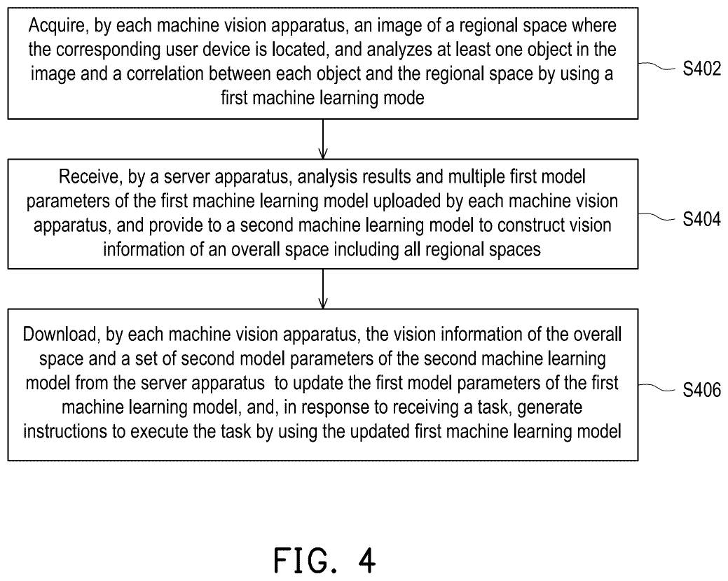

FIG. 4 is a flowchart of the machine vision method according to an embodiment of the disclosure. Referring to FIG. 2, FIG. 3, and FIG. 4 simultaneously, the machine vision method of this embodiment is adapted for the machine vision system 10 in FIG. 2 and the machine vision apparatus 16 in FIG. 3.

In Step S402, each machine vision apparatus 16 acquires an image of a regional space where the corresponding user device 14 is located, and analyzes at least one object in the image and a correlation between each object and the regional space by using a first machine learning model.

In some embodiments, the first machine learning model includes a first privacy visual language model (PVLM). The processor 166 of the machine vision apparatus 16 uses the first privacy visual language model to identify objects in the image and analyze the correlation between each object and the regional space to generate regional contextualized embeddings of each object in the regional space. The regional contextualized embeddings include image token of the identified object and text token used to describe the object. The first privacy visual language model may further link the identified personnel with objects in the space and perform scene analysis to determine which objects people pass by and what actions they perform, thus obtaining the correlation between each object and the regional space.

In some embodiments, the first machine learning model further includes a regional AI model. The processor 166 of the machine vision apparatus 16 may train the regional AI model by inputting the regional contextualized embeddings of each object and the actions and identity of the identified object into the regional AI model with respect to each of multiple tasks, so as to generate a set of model parameters adapted for the regional AI model to generate instructions to execute the respective task. The trained regional AI model is then used to execute multiple tasks.

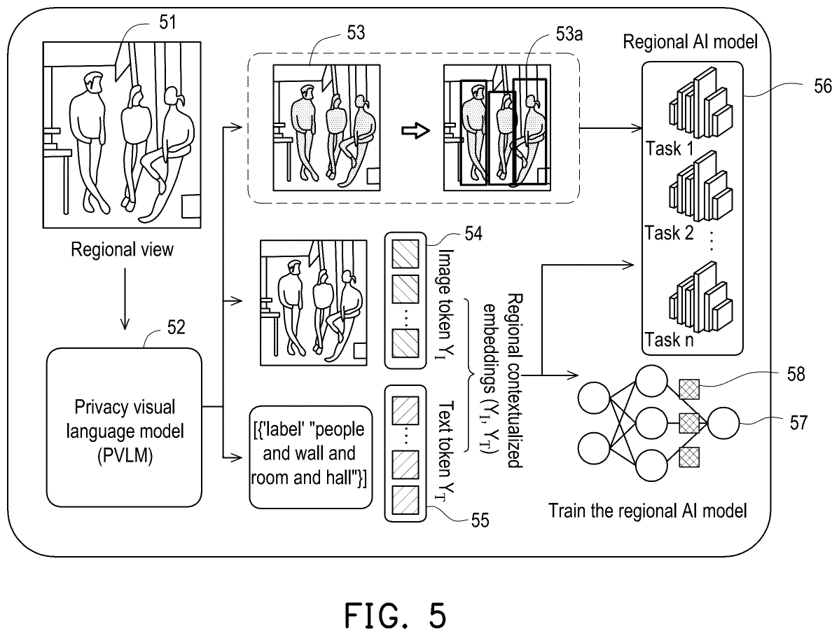

In detail, FIG. 5 is a schematic diagram of task execution and AI model training according to an embodiment of the disclosure. Referring to FIG. 5, the processor 166 of the machine vision apparatus 16, for example, acquires an image of a regional space where the corresponding user device 14 is located as a regional view 51, and identifies objects in the image and de-identifies sensitive images (such as faces, human figures) by using a privacy visual language model 52. The objects include people, tables, chairs, and other objects located in the regional space. The privacy visual language model 52 generates an image token 54 and a text token 55 of each object by identifying the outline, color, size, and other features of each object in the image, where the image token 54 is the image of the object, and the text token 55 is the text describing the object. The processor 166, for example, trains a regional AI model 57 by inputing an image token Y_{I} and a text token Y_{T} of each object as regional contextualized embeddings (Y_{I}, Y_{T}) into the regional AI model 57, with respect to each of various tasks, so as to generate model parameters 58 of instructions adapted for the regional AI model to execute the respective task. Through the process of acquiring images of the regional space and inputting into the regional AI model 57, the regional AI model 57 may learn the actions (including instructions to execute the actions) needed to execute tasks in that regional space, thereby training the regional AI model 57.

In detail, the visual language model (VLM) achieves multi-modal interaction and reasoning between text and images by fusing visual and language information, and may be applied to various tasks such as image classification, text generation, image description, and spatial navigation. The privacy visual language model 52 of this embodiment adds a privacy protection mechanism to the conventional visual language model. When an object is identified as a person from an image, then de-identification processing is performed on the face image and/or human figure image of that object, for example, by covering the human figure with a human figure mask to generate a de-identified image. By converting the face image into de-identified features, the identity of the object may be identified, and by converting the human figure image into de-identified features, the actions (including, for example, waving, standing, sitting, lying down, running) of the object and the correlation thereof with the regional space may be identified. In this way, the privacy of personnel appearing in the regional space can be protected while obtaining the necessary vision information of the regional space.

In the embodiment, when the object is identified as a person, the processor 166 of the machine vision apparatus 16 further uses the privacy visual language model 52 to perform de-identification processing on the face image of each object to generate de-identified features, and compare the de-identified features with pre-stored features in a feature database stored in the storage device 164 to identify the identity of the object.

In some embodiments, the privacy visual language model 52 includes, for example, a deep learning (DL) model, and the processor 166 may use the deep learning model to perform de-identification processing on the regional view 51. The deep learning model has object detection functionality that can recognize an object 53a in the input regional view 51 and cover the object 53a in the image to generate a de-identified image 53. Since the object 53a in the de-identified image has been covered, even if the de-identified image 53 is leaked, personnel viewing the de-identified image 53 still cannot identify the identity of the object 53a. Therefore, the de-identified image 53 may protect the privacy of the object 53a. In some embodiments, the deep learning model includes a deep neural network (DNN).

In some embodiments, the privacy visual language model 52 (e.g. deep learning model) may acquire the face image of the object 53a from the input image 51 and perform de-identification operations on the face image to generate one or more de-identified features. The processor 166 utilizes, for example, the trained regional AI model 57 to determine whether the de-identified features match the pre-stored features with respect to various tasks 56 (including tasks 1 to n) in the feature database to generate a verification result. The processor 166 may execute the de-identification operations based on, for example, a differential privacy algorithm to generate de-identified features in less time, or the processor 166 may execute the de-identification operations based on a homomorphic encryption algorithm or other encryption algorithms, and the disclosure is not limited thereto. If the de-identified features match the pre-stored features (for example, the similarity between the de-identified features and the pre-stored features is greater than a threshold), then it is indicated that the identity of the object 53a is the specific personnel corresponding to the pre-stored features. Accordingly, the processor 166 may generate a successful verification result. If the de-identified features do not match any pre-stored features (for example, the similarity between the de-identified features and the pre-stored features is less than or equal to the threshold), then it is indicated that the identity of the object 53a is unknown. Accordingly, the processor 166 may generate a failed verification result. After generating the verification result, the processor 166 may output the verification result for user reference.

To establish the feature database, the processor 166 may obtain multiple historical images of multiple personnel, and perform de-identification operations on the multiple historical images according to the deep learning model to generate multiple historical de-identified features. The processor 166 may establish the feature database according to the multiple historical de-identified features. The feature database may include one or more historical de-identified features corresponding to the identity of specific personnel. The feature database is obtained, for example, from an embedded space or loss function, such as AdaFace or ArcFace, which includes optimizing the margin of geodesic distance through the correlation of angles or radians in a normalized hypersphere.

On the other hand, the processor 166 may perform de-identification operations on the face image of the object 53a to generate a de-identified label, in which the de-identification operations for generating the de-identified label may be the same as or different from the de-identification operations for generating the de-identified features, that is, the de-identified label and the de-identified features may be the same or different. In some embodiments, the processor 166 may execute the de-identification operations for generating the de-identified label based on, for example, a homomorphic encryption algorithm to generate a more easily recognizable de-identified label, or the processor 166 may execute the de-identification operations based on other encryption algorithms (for example, differential privacy algorithm). In one embodiment, the processor 166 may execute the de-identification operations based on homomorphic encryption algorithm according to post-quantum-secure de-identification technology.

As shown in FIG. 2, after completing the training of the regional AI model, the processor 166 of the machine vision apparatus 16 may utilize the communication device 162 to upload the regional context embeddings and the regional model parameters of the regional AI model to the server apparatus 12 through a privacy-secure channel.

Returning to the process in FIG. 4, in Step S404, the server apparatus 12 receives the analysis results and multiple first model parameters of the first machine learning model uploaded by each machine vision apparatus 16, and provides to the second machine learning model to construct vision information of the overall space including all regional spaces.

In some embodiments, the server apparatus 12, for example, fuses the analysis results uploaded by each machine vision apparatus 16 by using the second privacy visual language model to generate multiple global context embeddings of each object in the overall space. Furthermore, the server apparatus 12 uses the first model parameters of the first machine learning model uploaded by each machine vision apparatus 16 to train the global AI model to construct vision information of complete objects. In some embodiments, the global AI model, for example, performs federated learning by using the first model parameters of the first machine learning model uploaded by each machine vision apparatus 16 to generate a set of second model parameters. Alternatively, the global AI model may take the average of the first model parameters of the first machine learning model uploaded by each machine vision apparatus 16 to generate a set of second model parameters.

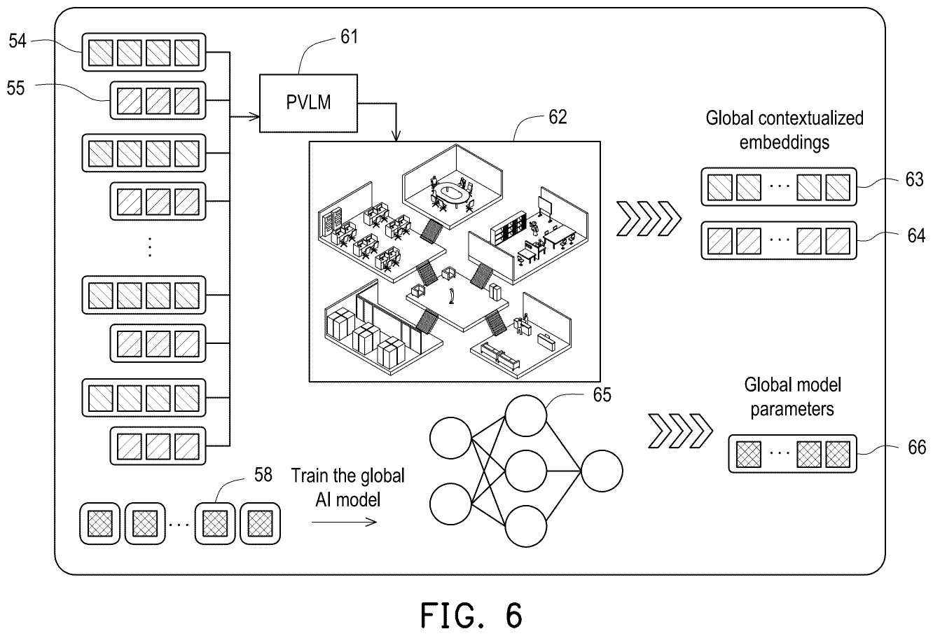

In detail, FIG. 6 is a schematic diagram of vision fusion and a global AI model training according to an embodiment of the disclosure. Referring to FIG. 6, after receiving the image token 54, the text token 55, and the model parameters 58 of the regional AI model 57 uploaded by each machine vision apparatus 16, the server apparatus 12 then uses a privacy visual language model 61 to fuse the image token 54 and the text token 55 uploaded by each machine vision apparatus 16 to construct vision information 62 of the overall space, and generate multiple global context embeddings of each object in the overall space, including the image token 63 and the text token 64.

On the other hand, the server apparatus 12 further inputs the model parameter 58 of the regional AI model 57 received into the global AI model 65 to train the global AI model 65, and generate the global model parameter 66. The model parameter 58 of the regional AI model 57 uploaded by each machine vision apparatus 16 is the optimized parameter after the regional AI model 57 is well-trained, which includes all knowledge of that regional space. Therefore, after being trained through the model parameters 58, the global AI model 65 possesses knowledge of the overall space including all regional spaces.

As shown in FIG. 2, after completing the training of the global AI model, the server apparatus 12 may provide the machine vision apparatus 16 with regional model parameters of the global AI model and global context embeddings for download through a privacy-secure channel, so as to obtain vision information and knowledge of the overall space.

Returning to the process in FIG. 4, in Step S406, each machine vision apparatus 16 downloads the vision information of the overall space and the set of second model parameters of the second machine learning model from the server apparatus 12 to update the first model parameters of the first machine learning model, and, in response to receiving a task, generates instructions to execute the task by using the updated first machine learning model. In this embodiment, each machine vision apparatus 16, in response to the user device 14 receiving the task, generates instructions to execute the task by using the updated first machine learning model, and sends the instructions to the user device 14, but the disclosure is not limited thereto.

In some embodiments, the processor 166 of the machine vision apparatus 16, for example, uses the downloaded vision information (including global context embeddings) of the overall space to update the first privacy visual language model, and uses the downloaded model parameters of the global machine learning model to update the model parameters of its own regional machine learning model.

Afterwards, the processor 166 of the machine vision apparatus 16, in response to the user device 14 receiving the task, for example, first acquires the current image of the regional space where the user device 14 is located, analyzes the objects in the current image by using the updated first privacy visual language model, and identifies the identity and action of the object. Specifically, the processor 166 performs de-identification processing on the face image of the object in the current image to generate de-identified features, and compare the de-identified features with pre-stored features in the feature database to identify the identity of the object. In addition, the processor 166 may further perform action identification on the human figure mask of the object in the current image to determine whether the object has dangerous actions, such as standing, sitting, running. Combined with the analysis results (context embeddings) of the first privacy visual language model, the regional AI model may be driven to execute complex tasks and generate instructions to execute the task.

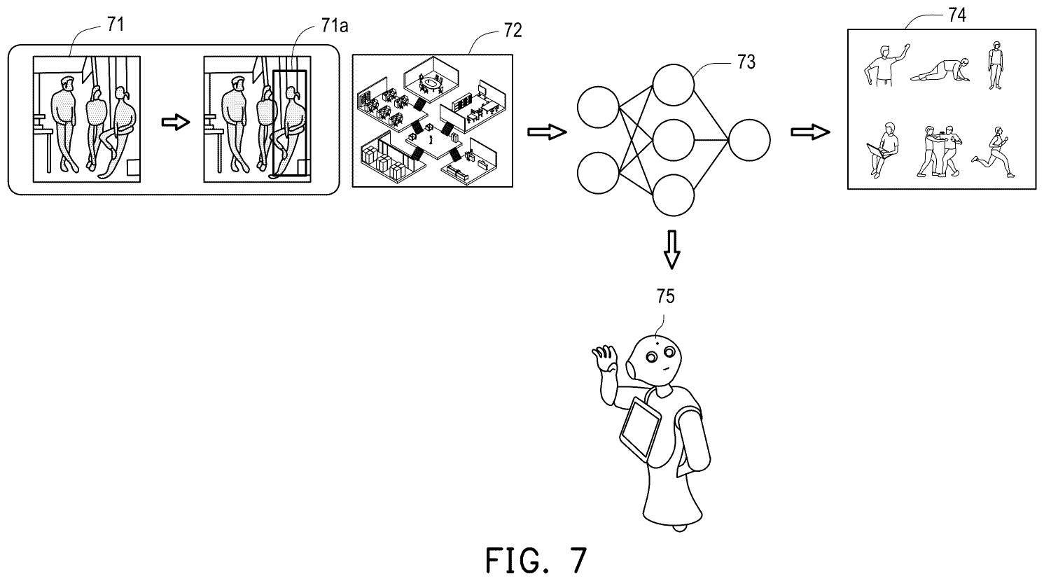

Specifically, FIG. 7 is a schematic diagram of executing a task according to an embodiment of the disclosure. Referring to FIG. 7, when a robot 75 receives a task, the processor 166 of the machine vision apparatus 16, for example, acquires the current image of the regional space where the robot 75 is located, and de-identifies the acquired image by using the updated privacy visual language model to obtain a de-identified image 71 and the correlation between an object 71a therein and the regional space, as well as analyzes actions 74 of each object 71a (including waving, lying down, standing, sitting, running or other specific actions), and then uses the updated regional AI model 73 to use the regional context embeddings, actions, and identities of each object to generate instructions for controlling the robot 75 to execute the task. Since the regional AI model 73 has learned the vision information 72 of the overall space, it is able to generate instructions adapted for the robot 75 to execute tasks in the regional space based on the correlation between each object in the regional space and the regional space, as well as the actions 74 of each object, and send the instructions to the robot 75 to control the robot 75 to execute the task according to the instructions. In addition, after being updated with the model parameters of the global AI model, the regional AI model 73 has acquired object information of all regions in the overall space, thereby improving the accuracy of human/object recognition.

Based on the machine vision apparatus 16 having acquired the vision information of the overall space, the visual range thereof has expanded from the regional space to the overall space, and thus the types and scope of tasks it may execute can be extended to the overall space. The following lists many application examples to explain the process of the machine vision apparatus 16 executing tasks.

Task 1: When the manager enters the building and walks through the lobby toward the elevator, deliver documents to him when he exits the elevator. Assuming the manager's office is located on the second floor, when the manager enters the building, the machine vision apparatus disposed in the lobby camera can identify the manager's identity and actions by analyzing the images captured by the lobby camera, and estimate the time the manager takes to walk and wait for the elevator, then upload the analysis results to the cloud/centralized server. After collecting and integrating the analysis results uploaded by various machine vision apparatuses, the cloud/centralized server can provide the integrated vision information to the robot, enabling the robot to timely obtain the documents and move to the front of the elevator on the second floor to wait, thereby delivering the documents to the manager when he steps out of the elevator. The images uploaded to the cloud/centralized server are processed with facial and humanoid obfuscation, so even if the images are obtained by others, the identity of the personnel therein cannot be identified.

Task 2: When a customer sits down, deliver the menu to the customer, and when a customer raises hand, go to the customer's table to take the order. Assuming a customer enters the restaurant for dining, the machine vision apparatuses in multiple cameras disposed in the restaurant can identify the actions of each customer in the restaurant by analyzing the images captured by the cameras, and upload the analysis results to the cloud/centralized server. After collecting and integrating the analysis results uploaded by various machine vision apparatuses, the cloud/centralized server can provide the integrated vision information to the robot. Therefore, when someone sits down in the restaurant, the robot that has obtained the vision information knows the location of the customer sitting down, thereby moving to that location to deliver the menu to the customer. Similarly, when a customer in the restaurant raises the hand, the robot that has obtained the vision information knows the location of the customer raising the hand, thereby moving to that location to take the customer's order.

Task 3: When someone enters the bathroom, monitor their safety. When someone enters the bathroom, the machine vision apparatus disposed in the camera outside the bathroom can identify the identity and actions of the personnel entering the bathroom by analyzing the images captured by the camera, and upload the analysis results to the cloud/centralized server. After collecting and integrating the analysis results uploaded by various machine vision apparatuses, the cloud/centralized server can provide the integrated vision information to the cleaning robot, and control the cleaning robot to switch to privacy mode to monitor the safety of that personnel. The cleaning robot, for example, enters the bathroom to check if the personnel has fallen or called for help after the personnel has been in the bathroom for more than a predetermined time. The images uploaded to the cloud/centralized server are processed with facial and humanoid obfuscation, thereby protecting the privacy of personnel entering the bathroom.

Task 4: When there are multiple robodogs patrolling on different floors of a building, the vision information captured by the robodogs may be integrated in the cloud/centralized server and shared among the robodogs, so as to identify a safety status of the site. When anyone of the robodogs identifies a suspicious individual or behavior, or estimates there is a dangerous event on the site, other robodogs may come to support immediately, thereby enhancing the security of the building.

In summary, the machine vision system, method, and apparatus of embodiments of the disclosure apply a unique multi-modal privacy visual language model (PVLM), which performs excellently in machine vision processing and secure de-identification, achieving over 99% accuracy in real-time identity image monitoring. The machine vision apparatus can be easily integrated with existing devices or robots equipped with cameras through hardware interfaces such as USB and PCIe, achieving comprehensive visual fusion, improving object image recognition accuracy to over 90%, and reducing the overall energy consumption of AI computation by approximately 30%.

In the machine vision apparatus, PVLM allows real-time interaction with people and environments, supporting precise machine intelligence tasks both online and offline. When interacting with robots, the machine vision apparatus allows the use of voice interfaces to prompt PVLM instructions. Each device with a camera can contribute to unified visual understanding, thereby improving the overall accuracy of the system. The machine vision apparatus, by integrating advanced artificial intelligence and privacy technology, provides powerful solutions for intelligent institutions and law enforcement departments, ensuring efficient task execution and sound privacy protection.

In the server apparatus, federated learning and homomorphic encryption technology may ensure secure communication with the machine vision apparatus. This configuration allows for secure merging and updating of contextual embeddings and model parameters, thereby enhancing visual recognition and task execution. This process may ensure accurate event triggering and task completion while safeguarding sensitive data.

From the user's perspective, the machine vision apparatus of the embodiment of the disclosure is designed with privacy protection as a priority, while providing efficient machine/robot intelligence capabilities through multi-view fusion. The multi-modal PVLM model ensures that users can observe and track specific activities/behaviors (such as access control, security threat detection, or demand service triggering) under multiple views without compromising personal privacy. The user interface further allows authorized personnel to prompt robot/machine instructions through voice input, making it a tool for users to easily interact with robots/machines.

From the perspective of materials and components, the machine vision apparatus of the embodiment of the disclosure utilizes powerful graphics processors (GPUs) and optimized coupled multi-modal deep neural networks (DNN) and PVLM models as well as multi-view fusion, which may achieve high-performance image processing and identification tasks. In addition, the machine vision apparatus adopts privacy protection mechanisms, federated learning, differential privacy, and quantum-secure homomorphic encryption, which may help minimize ecological impact by reducing the risk of data leakage and unauthorized access.

The machine vision apparatus is designed to operate on edge and centralized/cloud computing platforms, with offline operation and online learning capabilities, thereby providing flexibility and scalability to meet various robot service requirements. The machine vision apparatus may be easily configured through plug-and-play hardware and privacy-secure connections, enabling seamless updates and ensuring that edge devices can obtain the latest advances in privacy-enhancing technology.

Overall, the machine vision apparatus of the embodiment of the disclosure prioritizes user benefits, privacy protection, and ecological considerations, making it an advanced solution in the field of privacy-focused multi-modal intelligent robot systems.

Based on the above, the machine vision system, method, and apparatus of the embodiments of the disclosure may be applied to the following institutions/fields.

Law enforcement and security agencies: For monitoring, threat detection, and access control, while ensuring privacy protection.

Healthcare: Used in hospitals and clinics to monitor patient activities and ensure secure data processing.

Smart homes/offices: Enhancing productivity, security, automation, and environmental monitoring within residential and office spaces.

Smart cities: For traffic management, public safety, and environmental monitoring.

Retail and shopping centers: Enhancing security and customer experience through intelligent monitoring and service automation.

Manufacturing and warehousing: Improving operational efficiency and safety through robot assistance and real-time monitoring.

Educational institutions: For campus security and smart infrastructure management.

Transportation: For security and operational management at airports, train stations, and ports.

Government agencies: For secure data processing and monitoring of public spaces, while maintaining privacy.

What is claimed is:

1. A machine vision system, comprising:
a plurality of machine vision apparatuses respectively disposed to acquire an image of a regional space where each of the machine vision apparatuses is located, and analyzing at least one object in the image and a correlation between each of the objects and the regional spaces by using a first machine learning model; and
a server apparatus receiving analysis results and a plurality of first model parameters of the first machine learning model uploaded by each of the machine vision apparatuses, and providing to a second machine learning model to construct vision information of an overall space comprising all of the regional spaces, wherein
each of the machine vision apparatuses downloads the vision information of the overall space and a set of second model parameters of the second machine learning model from the server apparatus to update the first model parameters of the first machine learning model, and, in response to receiving a task, generates instructions to execute the task by using the updated first machine learning model.

2. The machine vision system according to claim 1, wherein the machine vision apparatus comprises using a first privacy visual language model (PVLM) to identify the objects in the images, and analyzing the correlation between each of the objects and the regional spaces to generate regional contextualized embeddings of each of the objects in the regional spaces, wherein the machine vision apparatus further performs de-identification processing on a face image of each of the objects to generate de-identified features, and compares the de-identified features with pre-stored features in a feature database to identify an identity of the object.

3. The machine vision system according to claim 2, wherein the machine vision apparatus further analyzes a human figure and an action of each of the objects by using the first privacy visual language model, and covers a human figure mask on the human figure to generate a de-identified image.

4. The machine vision system according to claim 3, wherein the machine vision apparatus further inputs the regional contextualized embeddings, the action and the identity of each of the objects into a regional AI model, and trains the regional AI model using a plurality of tasks to generate a set of model parameters of the instructions adapted for the regional AI model to execute the task.

5. The machine vision system according to claim 2, wherein the regional contextualized embeddings comprise image tokens and text tokens of the objects, and the first privacy visual language model further generates image caption, image question answering, and space navigation between the objects and the image tokens or the text tokens.

6. The machine vision system according to claim 1, wherein the server apparatus comprises fusing the analysis results uploaded by each of the machine vision apparatuses by using a second privacy visual language model to generate a plurality of global contextualized embeddings of each of the objects in the overall space.

7. The machine vision system according to claim 6, wherein the server apparatus further trains a global AI model by using the first model parameters of the first machine learning model uploaded by each of the machine vision apparatuses to generate the set of second model parameters adapted for identifying all of the objects in the overall space.

8. The machine vision system according to claim 7, wherein the global AI model comprises performing federated learning by using the first model parameters of the first machine learning model uploaded by each of the machine vision apparatuses to generate the set of second model parameters.

9. The machine vision system according to claim 1, wherein the machine vision apparatuses are respectively disposed in corresponding ones of a plurality of user devices, each of the machine vision apparatuses, in response to a user device receiving the task, acquires a current image of the regional space where the user device is located, analyzes the objects in the current image of the regional space and the correlation between each of the objects and the regional space by using the updated first machine learning model, obtains the instructions to execute the task, and sends the instructions to the user device.

10. The machine vision system according to claim 9, wherein each of the machine vision apparatuses is integrated with at least one of a corresponding one of the user devices and the server apparatus into a single device.

11. A machine vision method, adapted for a machine vision system comprising a plurality of machine vision apparatuses and a server apparatus connected to each of the machine vision apparatuses, and the method comprises:
acquiring, by each of the machine vision apparatuses, an image of a regional space where each of the machine vision apparatuses is located, and analyzing at least one object in the image and a correlation between each of the objects and the regional spaces by using a first machine learning model;
receiving, by the server apparatus, analysis results and a plurality of first model parameters of the first machine learning model uploaded by each of the machine vision apparatuses, and providing to a second machine learning model to construct vision information of an overall space comprising all of the regional spaces; and
downloading, by each of the machine vision apparatuses, the vision information of the overall space and a set of second model parameters of the second machine learning model from the server apparatus to update the first model parameters of the first machine learning model, and, in response to receiving a task, generating instructions to execute the task by using the updated first machine learning model.

12. The method according to claim 11, wherein analyzing, by each of the machine vision apparatuses, the at least one object in the image and the correlation between each of the objects and the regional spaces by using the first machine learning model comprises:
using a first privacy visual language model to identify the objects in the images, and analyzing the correlation between each of the objects and the regional spaces to generate regional context embeddings of each of the objects in the regional spaces; and
performing de-identification processing on a face image of each of the objects to generate de-identified features, and comparing the de-identified features with pre-stored features in a feature database to identify an identity of the object.

13. The method according to claim 12, wherein analyzing, by each of the machine vision apparatuses, the at least one object in the image and the correlation between each of the objects and the regional spaces by using the first machine learning model further comprises:
analyzing a human figure and an action of each of the objects by using the first privacy visual language model, and covering a human figure mask on the human figure to generate a de-identified image.

14. The method according to claim 13, wherein analyzing, by each of the machine vision apparatuses, the at least one object in the image and the correlation between each of the objects and the regional spaces by using the first machine learning model further comprises:
inputting the regional context embeddings, the action and the identity of each of the objects into a regional AI model, and training the regional AI model using a plurality of tasks to generate a set of model parameters of the instructions adapted for the regional AI model to execute the task, wherein the regional contextualized embeddings comprise image tokens and text tokens of the objects, and executing visual language model applications comprising at least one of image description, image question answering, and space navigation between the objects and the image tokens or the text tokens.

15. The method according to claim 11, wherein constructing, by the server apparatus, the vision information of the overall space comprising all of the regional spaces by using the second machine learning model comprises:
fusing the analysis results uploaded by each of the machine vision apparatuses by using a second privacy visual language model to generate a plurality of global context embeddings of each of the objects in the overall space.

16. The method according to claim 15, wherein constructing, by the server apparatus, the vision information of the overall space comprising all of the regional spaces by using the second machine learning model further comprises:
training a global AI model by using the first model parameters of the first machine learning model uploaded by each of the machine vision apparatuses to generate the set of second model parameters adapted for identifying all of the objects in the overall space.

17. The method according to claim 16, wherein the global AI model comprises performing federated learning by using the first model parameters of the first machine learning model uploaded by each of the machine vision apparatuses to generate the set of second model parameters.

18. The method according to claim 11, wherein the machine vision apparatuses are respectively disposed in corresponding ones of a plurality of user devices, and generating, by each of the machine vision apparatuses, the instructions to execute the task by using the updated first machine learning model in response to receiving the task comprises:
acquiring a current image of the regional space where the user device is located, analyzing the objects in the current image of the regional space and the correlation between each of the objects and the regional space by using the updated first machine learning model, and obtaining the instructions to execute the task; and
sending the instructions to the user device.

19. A machine vision apparatus, disposed in a user device, comprising:
a communication device communicatively connected with a server apparatus;
a storage device storing a plurality of first model parameters of a first machine learning model; and
a processor coupled to the storage device, and configured to:
acquire an image of a regional space where the user device is located, analyze at least one object in the image and a correlation between each of the objects and the regional spaces by using a first machine learning model, and upload analysis results to a server apparatus;
download vision information of an overall space comprising all of the regional spaces and a set of second model parameters of a second machine learning model from the server apparatus to update the first model parameters of the first machine learning model, wherein the server apparatus collects the analysis results and the first model parameters of the first machine learning model uploaded by a plurality of machine vision apparatuses, and provides to the second machine learning model to construct the vision information of the overall space comprising all of the regional spaces; and
generate instructions to execute a task by using the updated first machine learning model in response to the user device receiving the task, and send the instructions to the user device.

20. The machine vision apparatus according to claim 19, wherein the machine vision apparatus is integrated with at least one of the user device and the server apparatus into a single device.
